(19) United States
(12) Patent Application Publication
(10) Pub. No.: US 2007/0001323 A1
(43) Pub. Date: Jan. 4, 2007

(54) Multi-layered membrane for air diffuser

(76) Inventor: Seoungil Kang, Poughkeepsie, NY (US)

Correspondence Address: AHSAN & ASSOCIATES, P.O. BOX 251, HOPEWELL JUNCTION, NY, 12533, US

(21) Appl. No.: 11/435,577

(22) Filed: May 16, 2006

(30) Foreign Application Priority Data
May 18, 2005 (KR) 2005-0041410

(51) Int. Cl. B01F 3/04

(52) U.S. Cl. 261/122.1

(57) ABSTRACT

This invention is about the multi-layered membrane of disk-typed and tube-typed membrane air diffuser. This system is installed in the aeration tank of the sewage and waste water treatment system that is used to make the air, which was supplied from the blower, fine bubbles to spray them so that the oxygen in the air can be efficiently dissolved into the sewage and waste water. By doing it, this system analyzes and removes the biochemical oxygen demand and suspended solids biologically, and enables to be appropriately mixed so that the sedimentation within the aeration tank can be prevented.

### FIELD OF THE INVENTION

This invention is about the multi-layered membrane of disk-typed and tube-typed membrane air diffuser. This system is installed in the aeration tank of the sewage and waste water treatment system that is used to make the air, which was supplied from the blower, fine bubbles to spray them so that the oxygen in the air can be efficiently dissolved into the sewage and waste water. By doing it, this system analyzes and removes the biochemical oxygen demand and suspended solids biologically, and enables to be appropriately mixed so that the sedimentation within the aeration tank can be prevented.

### PURPOSE AND SUMMARY OF THE INVENTION

The purpose of the invention is a device that sprays the air, which was flowed in from the blower, through the membrane infinitesimally among various processes that supply oxygen to the microorganisms in the aeration tank to purify waste waters, related to the process where sewage and waste waters are biologically processed. The membrane used for this purpose are the ones composed of single material and single layer such as EPDM, SILICON, and NITRIL.

Therefore, in one aspect this invention comprises a disk-typed membrane for air diffuser that prevents the suspended solids from being adhered under water by coating PTFE in the multi-layer structure on the both surfaces of EPDM or NITRIL membranes, and that has acid-resistance, resistance to chemical, and heat resistance.

In another aspect this invention comprises a disk-typed membrane for air diffuser that prevents the suspended solids from being adhered under water by coating PTFE in the multi-layer structure on the both surfaces of EPDM or NITRIL membranes, and that has acid-resistance, resistance to chemical, and heat resistance, wherein the multi-layered tube-typed membrane for air diffuser whose membrane is made in a tube form.

### BRIEF DESCRIPTION OF THE DRAWINGS

The features of the invention believed to be novel and the elements characteristic of the invention are set forth with particularity in the appended claims. The drawings are for illustration purposes only and are not drawn to scale. Furthermore, like numbers represent like features in the drawings. The invention itself, both as to organization and method of operation, may best be understood by reference to the detailed description which follows taken in conjunction with the accompanying drawings in which:

FIG. 1 represents the cross-section of an assembled air diffuser according to this invention.

FIG. 2 is a cross-section illustrating the PTFE, which was prepared for the both surfaces of membrane for air diffuser according to this invention.

FIG. 3 represents a process where PTFE is coated on the membrane for air diffuser according to this invention.

### DETAILED DESCRIPTION

Target Technological Task of Invention

In this invention, the membrane is manufactured by coating PTFE in the multi-layer structure on the both surfaces of the conventional EPDM or NITRIL membrane (MEMBRANE 21), so that the acid-resistance, resistance to chemical, heat resistance, and the function that can prevent foreign elements from being adhered, which are the functions not provided by EPDM and NITRIIL membrane, can be provided.

Composition and Action of Invention

The invention for achieving the above purposes has the following characteristics;

This invention coats PTFE 23 on both surfaces of membrane 21 whose main material is EPDM or Nitril. That is, this invention adds the characteristics of PTFE based on the physical property of EPDM membrane 21 so that the function and durability of the membrane within the sewage and waste water can increase.

Generally, in case of the multi-layered membrane 13 with coating of EPDM and PTFE, the PTFE coating layer 23 is likely to be seeded from the EPDM surface if there is no pretreatment. In case of PTFE layer coated after pretreatment, the layer was processed through a hardening process from heat treatment so that the PTFE coating layer 23 should not separate during the manufacturing process of bending the layer or punching a pore.

The air diffuser of PTFE coating membrane of this invention has the characteristics as follows; it prevents suspended solids from being adhered under water during a process where air is sprayed within the aeration tank of the sewage and waste water treatment system. Also, it has superior acid-resistance, and strong resistance to chemical.

The attached drawings are referred to for a practical example according to this invention as shown below.

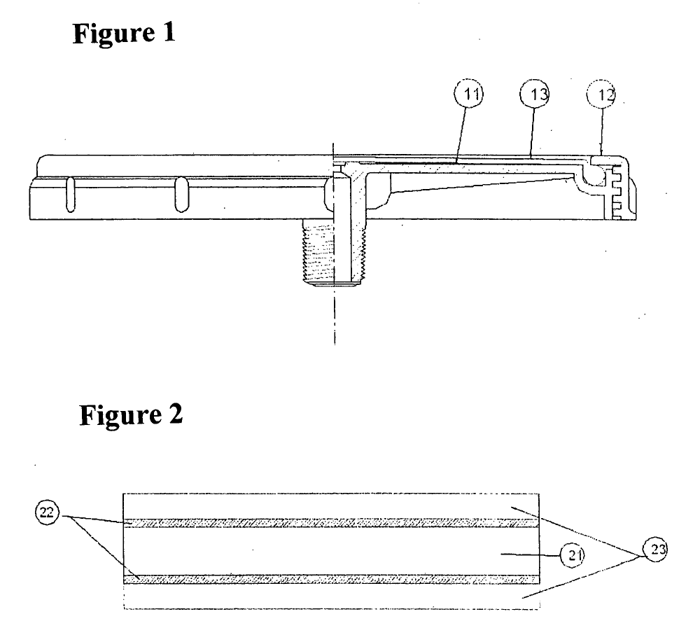

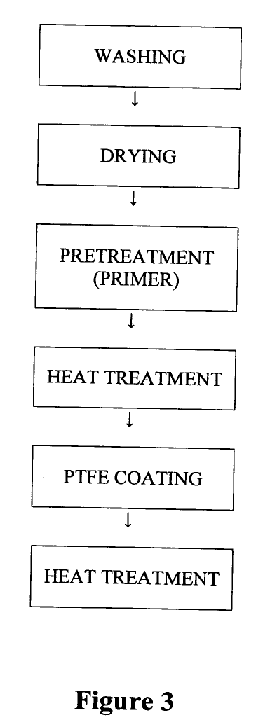

The compositions of the membrane air diffuser according to this invention are represented as shown in FIG. 1, FIG. 2, and FIG. 3. The multi-layered membrane (Membrane 13) is assembled into the air diffuser base (Base 11) and this assembly is tightened by a retaining nut (Retaining Nut 12). As for the function of the membrane air diffuser, the multi-layered membrane (Membrane 13) tightened by a retaining nut 12 is expanded by the air supplied through the orifice of the air diffuser base 11, and at this time, many slits, which were made by punching over the effective surface of the membrane 13, are opened while discharging equal fine bubbles of 1-2 mm sizes.

The manufacturing process of a membrane 13 on which PTFE 23 has been coated is described below by referring to FIG. 3.

Wash and dry both surfaces of EPDM or NITRIL membrane (21) and process them by (primer, 22), and then heat them for about 30 minutes in a heat treatment furnace.

Afterwards, coat a membrane, which was cooled off, with PTFE and plasticize it in the heat treatment furnace for over 20 minutes at over 100 degree for plasticity of the membrane.

Effect of Invention

As described above in detail, the air diffuser of multi-layer membrane of PTFE according to this invention has the following effects; It has strong resistance to chemical substances of strong corrosiveness flown into along with sewage or waste water. Also, it is safely prevented from the suspended solids such as CaCl₂ that is easily adhered to the EPDM membrane surface, and it has acid-resistance.

Description of sign for main parts of drawings or Figures, where

11: Base or air diffuser base

12: Retaining nut

13: Multi-layered membrane

21: EPDM, SILICON, NITRIL, membrane

22: Primer or Pretreatment

23: PTFE (Polytetrafluoroetyhylene) coating layer

FIG. 3 illustrates a process of washing the membrane 21, and drying the membrane 21, and then pretreatment or priming the membrane, which is followed by the heat treatment of the membrane. A PTFE coating 23 is then applied onto the membrane, which is followed by a heat treatment.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

1. (canceled)

2. (canceled)

3. A multi-layered membrane for an air diffuser, comprising:
(a) a first membrane, and
(b) at least one layer of PTFE over at least one surface of said first membrane.

4. The multi-layered membrane for an air diffuser of claim 3, wherein material for said first membrane is selected from a group consisting of EPDM, Silicon and NITRIL.

5. The multi-layered membrane for an air diffuser of claim 3, wherein shape for said multi-layered membrane is selected from a group consisting of disk-shaped membrane and tube-shaped membrane.

6. The multi-layered membrane for an air diffuser of claim 3, wherein said first membrane is primed prior to the application of said at least one layer of PTFE over at least one surface of said first membrane.

7. A process for forming a multi-layered membrane for an air diffuser, comprising the steps of:
(a) washing and drying a first membrane,
(b) priming at least one surface of said first membrane,
(c) heating treating said first membrane for about 30 minutes in a heat treatment furnace, and then allowing said first membrane to cool off,
(d) coating said cooled off first membrane with at least one layer of PTFE over at least one surface of said first membrane that has been primed, and forming a multi-layered membrane, and
(e) curing said multi-layered membrane in a heat treatment furnace for over 20 minutes at a temperature of over 100 degree for plasticity of said multi-layered membrane.

8. The process for forming a multi-layered membrane for an air diffuser of claim 7, wherein material for said first membrane is selected from a group consisting of EPDM, Silicon and NITRIL.

9. The process for forming a multi-layered membrane for an air diffuser of claim 7, wherein shape for said multi-layered membrane is selected from a group consisting of disk-shaped membrane and tube-shaped membrane.

10. A process for forming a multi-layered membrane for an air diffuser, comprising the steps of:
(a) washing and drying a first membrane,
(b) priming at least one surface of said first membrane,
(c) coating said cooled off first membrane with at least one layer of PTFE over at least one surface of said first membrane that has been primed, and forming a multi-layered membrane, and
(d) curing said multi-layered membrane in a heat treatment furnace for over 20 minutes at a temperature of over 100 degree for plasticity of said multi-layered membrane.

11. The process for forming a multi-layered membrane for an air diffuser of claim 10, wherein material for said first membrane is selected from a group consisting of EPDM, Silicon and NITRIL.

12. The process for forming a multi-layered membrane for an air diffuser of claim 10, wherein shape for said multi-layered membrane is selected from a group consisting of disk-shaped membrane and tube-shaped membrane.
